(19) United States
(12) Patent Application Publication
(10) Pub. No.: US 2016/0071226 A1
(43) Pub. Date: Mar. 10, 2016

(54) Method and System for Validating Compliance of Medical Records

(71) Applicant: Siemens Medical Solutions USA, Inc., Malvern, PA (US)

(72) Inventors: Ranjeet Karale, Bangalore (IN); Chandrashekara Rangapura Shettappa, Bengaluru (IN)

(21) Appl. No.: 14/477,914

(22) Filed: Sep. 5, 2014

(51) Int. Cl. G06Q 50/24; G06Q 10/00

(52) U.S. Cl. CPC G06Q 50/24; G06Q 10/00

(57) ABSTRACT

The invention relates to method and system for validating a medical record according to compliance rules governing the content of the medical record. The method includes receiving, by a processor, one or more medical records having access restrictions. Medical records may not be visible to a user while validating the medical record against one or more rules. Further, the content of the medical records are validated against at least one rule. Based on the result of the validation, it is determined if the medical record conforms to the at least one rule. Finally, a compliance report is generated which includes a level of compliance of the medical record with the at least one rule.

### FIELD OF THE INVENTION

This invention relates to a method and system for validating compliance of medical records.

### BACKGROUND

Medical records contain sensitive information associated with respective individuals. The medical records need to be handled with the highest level of privacy measures and restrictions. Also, medical records need to have all the required information without omitting any vital information. Due to disparate medical record management systems, there is a lot of inconsistency in the manner the medical records are maintained. For example, the medical record may not have information such as record creation date and sometimes the name of the patient. The absence of vital information in the medical record may result in delays in treating the patient, which may be very risky.

Further, due to the sensitive nature of the medical records, most of the countries and certain organizations have framed laws to ensure safety and privacy of the patients associated with the medical records. For example, the United States Health and Human Service Department is an authority which defines regulations related to transactions, code sets, privacy and security of medical records. In order to preserve the confidentiality of medical records certain laws and regulations are framed which the medical records need to comply with. In some cases, the medical record needs to comply with federal law and state laws to ensure confidentiality. Failing to adhere to the laws puts health care providers with risk. So it of paramount importance that the medical record complies with the laws concerning with privacy of medical records.

Generally, medical records are access restricted and may not be accessible to a hospital staff to check and validate the compliance of the medical record. In such as case, there is a need for a system which checks the compliance of medical records without exposing the contents of the medical records to unauthorized person. Further, the medical records may not include all the content which is vital during treatment. For example, the medical record may not include a tumour size or a clot location which is very vital for further diagnosis and treatment. Thus, there is a need for a system which can to check the integrity and compliance of the medical records without exposing the content of the medical record.

Accordingly, it is an object of the invention is to validate the compliance of the medical record according to one or more rules pertaining to privacy, completeness and legibility of medical records. Further, the record needs to be checked for access restrictions, audit controls, integrity and encryption standards for transmission of the medical record.

### SUMMARY OF THE INVENTION

The object of the present invention is achieved by providing a method and system for validating compliance of a medical record. The invention provides a method of validating a medical record according to compliance rules governing the content of the medical record. The method includes receiving, by a processor, one or more medical records. The medical record may be received from at least one of a database, a computing device and an imaging modality. The medical record may include at least one of personal details of a patient, a clinical condition, values and annotations associated with the clinical condition and the like. Further, the medical record includes access restrictions and can be accessed only by authorised personnel such as, a physician and a patient. The method further includes analyzing a content of the medical records against one or more rules. In an instance, the rules may include regulations pertaining to privacy, completeness and integrity of medical records specified by a regulatory authority. The rules may be stored in a database, which may be accessed locally or remotely. Further, the method includes determining if the medical record conforms to the one or more rules. The content of the medical record is compared against the rules to check if the content of the medical record conforms to the rules. Thereafter, the method includes generating a compliance report which includes a level of compliance of the record with at least one rule. For instance, the compliance report includes a level of data integrity, a level of integrity and robustness of the encryption standard used for securing the report. Further, the compliance report provides warnings if there are critical information missing, in the medical record, which is required according to the rules.

According to an aspect of the invention, the medical record is analyzed for parameters such as, access rights, presence or absence of information, authentication requirements, encryption standards and the like. The content of the medical records are parsed to analyze the aforementioned parameters.

According to another aspect of the invention, the one or more rules against which the content of the medical record is checked are selected using input means. For instance, the rules which are applicable for a particular medical record are individually selected from a rules database. The content of the medical record are checked against the selected rules and a compliance report is generated.

According to yet another aspect of the invention, the rules are based on at least one of an industry standard and a territorial standard. For example, the rules may be framed by the government of a country such as United States of America. In another instance, an organization such as Inter-Societal Commission for the Accreditation of Nuclear Medicine Laboratories (ICANL) has framed rules pertaining to the information that needs to be present in a medical record. For example, section 3A of the standard set by ICANL specifies that the medical record must contain the name of the procedure performed on a patient, type of dosage and an image description in case the record contains a diagnostic image.

In a variation of the invention, the content of the medical record is compared with one or more rules to validate the compliance of the medical record with one or more rules. The content of the medical record is parsed and compared with the rule. For example, an exemplary rule specifies that the date field is mandatory. A date field in the medical record is parsed to determine if the date is printed or empty. In case the date field is empty, then a warning is indicated in the compliance report highlighting the same.

In a variation of the invention, the comparison of the content of the medical record with the rules is performed without displaying the medical record. As the medical record is a sensitive document, the content of the medical record may not be shown to a user or a physician while performing the comparison. However, the compliance report associated with the medical record is accessible to the user.

In another variation of the invention, the rules are converted into an XML schema. The rules may be available in text format from various sources. The rules are then converted into at least one of, but not limited to, XML elements, XML attributes, and XPath expressions for facilitating the comparison of the content of the medical reports and the rules.

In yet another variation, the content of the medical record is compared against the XML schema to determine the conformance of the record with the rules. The content of the medical record is parsed and compared with the appropriate rules to check the compliance of the medical record. After the comparison, the result is provided in a compliance report.

In an embodiment, the compliance report includes at least one indication such as results of integrity tests, value of data, adherence to the rules and presence or absence of critical data.

In yet another embodiment, the compliance report includes one or more visual representations illustrating the at least one indication. For example, the compliance report includes the results of the comparison of the content of the medical record against the rules. Further, the compliance report can include one or more visual representations that represent the overall compliance of the medical record with a set of rules.

In yet another embodiment, the medical record includes at least one of an electronic medical record (EMR), an electronic health record (EHR), a medical image and a clinical record.

To facilitate the fulfilment of the object, the invention provides a system for validating a medical record according to compliance rules, wherein the system comprises a processor and a memory coupled to the processor. The memory includes a receiving module, configured to receive one or more medical records. The one or more medical records may include access restrictions. Further, the memory comprises a compliance validation module, configured to analyze a content of the medical records against one or more rules and determine if the medical record conforms to the one or more rules. Furthermore, the memory comprises a record generation module, configured to generate a record, wherein the record includes one or more indications of a level of compliance of the record with at least one rule.

In an aspect of the invention, the compliance validation module is configured to determine one or more rules to be compared against the content of the medical record. For example, the compliance validation module determines the rules to be compared against the medical record based on a user input. In this case, the user may select one or more rules against which the medical is validated. In another example, the compliance validation module determines the rules to be considered based on at least one of a geographic location and a type of medical record. In this case, if the medical record is to be validated for European standards, the compliance validation module may autonomously select a set of rules corresponding to the European regulations to validate a medical record.

In another embodiment, the one or more rules are selected by an input means. A user may select one or more rules against which the medical record is validated. The user may select the one or more rules from the rules database using input means such as, a mouse, a keyboard and a touch input.

In an exemplary embodiment, the compliance validation module is configured to retrieve one or more rules from a rules database. The rules database may be located remotely. The rules database may be updated automatically when there are changes to the existing set of rules.

In another embodiment, the compliance validation module is configured to convert the rules into XML (Extensible Markup Language) format. For example, if the rules are stored in text format, they are converted into XML format by the compliance validation module. Converting the rules to XML format enables easier comparison with the content of the medical record.

In yet another embodiment, the compliance validation module is configured to store one or more rules as an XML template. The rules may be in text format. The compliance validation module converts the rules from text format to XML format for facilitating the comparison.

In still yet another embodiment, the rules database is updated based on the changes to the one or more rules. The rules database may be updated either automatically or manually whenever there are changes to the set of rules. The rules may be changed by an industrial authority or by a local government.

In yet another embodiment, the report generation module is configured to generate a compliance report indicating at least one of data integrity, completeness, adherence to the rules, presence or absence of critical data, encryption type and the like. The report generation module is configured to generate a compliance report based on the rules that are considered for analyzing the medical record.

In yet another embodiment, the report generation module is configured to generate a compliance report including at least one visual indication illustrating the overall compliance of the medical record. For example, the visual indication includes a bar graph, a sector graph and the like.

The above mentioned and other features of the invention will now be addressed with reference to the accompanying drawings of the present invention. The illustrated embodiments are intended to illustrated, but not limit the invention.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 illustrates an exemplary block diagram of a computing device capable of validating a compliance of medical records, according to the present invention.

FIG. 2 illustrates an exemplary block diagram of medical record validation module according to the present invention.

FIG. 3 illustrates an exemplary environment for performing compliance validation of the medical records, according to the present invention.

FIG. 4 illustrates an exemplary compliance validation report, according to the present invention.

FIG. 5 illustrates an exemplary flow diagram of method steps for validating the compliance of the medical records, according to the present invention.

### DETAILED DESCRIPTION OF THE INVENTION

Various embodiments are described with reference to the drawings, wherein like reference numerals are used to refer like elements throughout. In the following description, for the purpose of explanation, numerous specific details are set forth in order to provide thorough understanding of one or more embodiments. It may be evident that such embodiments may be practiced without these specific details.

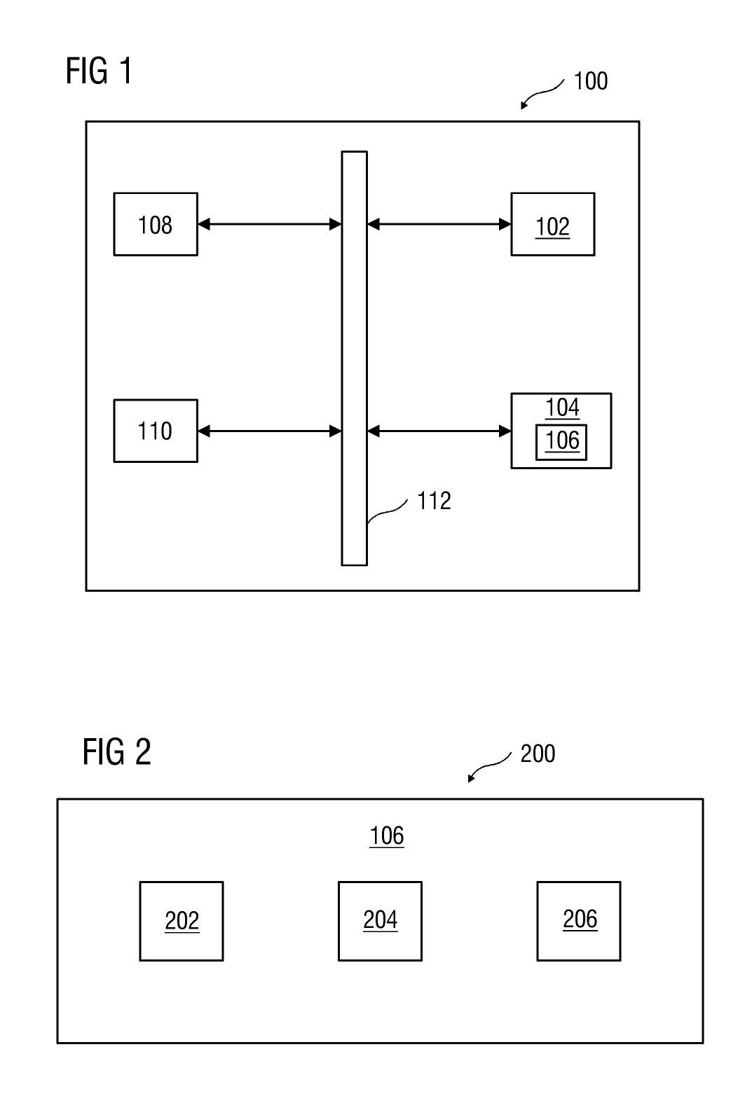

FIG. 1 illustrates a block diagram of an exemplary computing device 100 capable of validating compliance of medical records according to the present invention. The computing device 100 may be a personal computer, a laptop computer, a server computer, a tablet and the like. In FIG. 1, the computing device 100 comprises a processor 102, a memory 104, a storage unit 108, and input/output devices 110. The computing device includes a bus 112 which connects all the aforementioned components with each other.

The processor 102, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 102 may also include embedded controllers, such as generic or programmable logic devices or arrays, application specific integrated circuits, single-chip computers, and the like.

The memory 104 may be volatile memory and non-volatile memory. A variety of computer-readable storage media may be stored in and accessed from the memory 104. The memory 104 may include any suitable elements for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like. As depicted, the memory 104 includes a medical record validation module 106 for validating the compliance of one or more medical records, according to one or more embodiments described above.

The medical record validation 106 may be stored in the form of machine-readable instructions on any of the above-mentioned storage media and may be executed by the processor 102. For example, when executed by the processor 102, the machine readable instructions, causes the processor 102, to receive the medical documents and perform compliance validation of the medical records in accordance with one or more rules selected. Further, a compliance validation report is generated which includes at least one indication for denoting a degree of compliance of the medical record.

The storage unit 108 may be a non-transitory storage medium configured for storing files and databases. For example, the storage unit 108 contains one or more medical records to be validated for compliance. Further, the storage unit 108 may include one or more rules which are compared against the content of the medical records for validating the compliance of the medical records. It can be noted that medical records and the rules may be located at a remote server and may be accessed via a network connection.

The input/output devices 110 may include keyboard, keypad, monitor, touch sensitive display screen, mouse and the like. The input device/output devices 110 enable the user to interface with the computing device 100 for validating compliance of the medical records. For example, the input device may enable selection of one or more rules against which the content of the medical records is validated.

FIG. 2 illustrates an exemplary block diagram of the medical record validation module 106, according to an embodiment of the invention. The medical record validation module 106 includes a receiving module 202, a compliance validation module 204 and a report generation module 206. The receiving module 202 receives one or more medical records for performing compliance validation. The receiving module 202 receives medical records which can include, but not limited to, an electronic medical record (EMR), an electronic health record (EHR), a medical image and a clinical record. The medical record can include access restriction and are prohibited from being displayed publicly. The medical records may be viewed by authorized personnel such as the patient to which the medical record belongs or the physician who is treating the patient.

The compliance validation module 204 enables the computing device 100 to perform validation of the access restricted medical records against one or more rules. Further, the compliance validation module 204 is capable to performing the compliance validation of the medical records without exposing the content of the medical records. Furthermore, the compliance validation module 204 may be isolated during execution using techniques such as sandboxing. Further, the data processing performed by the compliance validation module 204 may be encrypted for additional security. The functions of the compliance validation module 204 may be monitored to ensure that sensitive data associated with the medical records are not exposed. The compliance validation module 204 is configured to determine one or more rules against which the medical record is validated. The compliance validation module 204 may be configured to determine the rules to be considered based on a user input. For example, a user may manually select one or more rules against which the content of the medical record is validated. In another example, the compliance validation module may be configured determine a set of rules automatically based the location. For example, if the compliance of the medical records is being checked in Europe, then the compliance validation module 204 automatically considers the European laws for validating the medical record. Further, the user may create one or more templates based on a requirement which may include one or more rules based on a user requirement. Such rule templates may be stored, locally or remotely, and used repeatedly. Thereafter, the compliance validation module 204 is configured to parse the medical record based on the rules that are determined. The content of the medical record is compared against the rules. For example, a rule may state that the medical record must include the physician's name. Based on the rule, the compliance validation module 204 parses the medical record for physician's name. In case the physician's name is present, the compliance validation module 204 marks that the rule is adhered by the medical record. In case the physician's name is not present in the medical record, the compliance validation module 204 is capable of generating an alert that the particular rule is not satisfied by the medical record. In the same way, the compliance validation module 204 is capable of analyzing the content of the medical report against all the rules which are considered for validation. While validating the medical records, the compliance validation module 204 does not display the contents of the medical record as the medical record is access restricted. The compliance validation module 204 is capable of comparing the medical record with the rules without displaying the contents of the medical record.

In an exemplary embodiment, the compliance validation module 204 may convert the rules which are considered into XML. The rules may be converted into XML components such as XML attributes, XML schema and XPath expression. The conversion of the rules into XML components may facilitate in comparison of the rules with the content of the medical records. A person skilled in the art will appreciate that the comparison of the content of the medical records with the rules may be performed using similar existing techniques.

In addition the compliance validation module 204 may be used to analyze the templates and remove the sections or fields in the medical record which are unnecessary for further processing. For example, a cardiac report may not require fields which refer to a lung ailment. Such unnecessary field in the medical report are removed while parsing the medical record. Further, the compliance validation module 204 is configured to detect aberrant data in the medical record. For example, if a date field of the medical record includes a number which is not within the bounds of the date is recognized and an alert is generated in the compliance validation report. Furthermore, the compliance validation module may detect copy-paste errors and procedural result mismatches. For example, copy paste error may include patient name mismatches in a single medical record. In another example, result mismatches may include a cardiology report having the results under the rectal study section. Such mismatches are reported as errors by the compliance validation module 204.

The report generation module 206 is capable of generating a compliance report based on the comparison performed by the compliance validation module 204. The compliance report includes one or more indications depicting the level of conformance of the content of the medical report with the rules. Further, the compliance report may include one or more visual indications such as a pie chart or a bar graph for illustrating the overall compliance of the medical reports. In case the medical report is found not adhering to one or more rules, such cases are highlighted in the compliance report to capture to attention of the staff. The compliance report may be accessible to the staff so that they can take corrective measures to ensure the compliance of the medical records. For example, a user after analyzing the compliance report may advise concerned personnel to fill in the missing details as highlighted in the compliance report. An exemplary compliance report is shown in FIG. 4 and details are provided in the forthcoming sections.

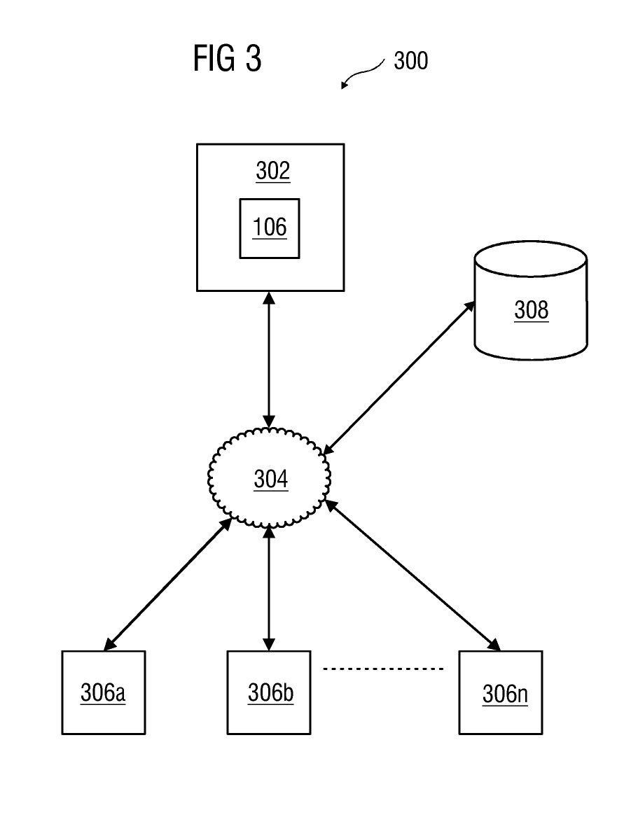

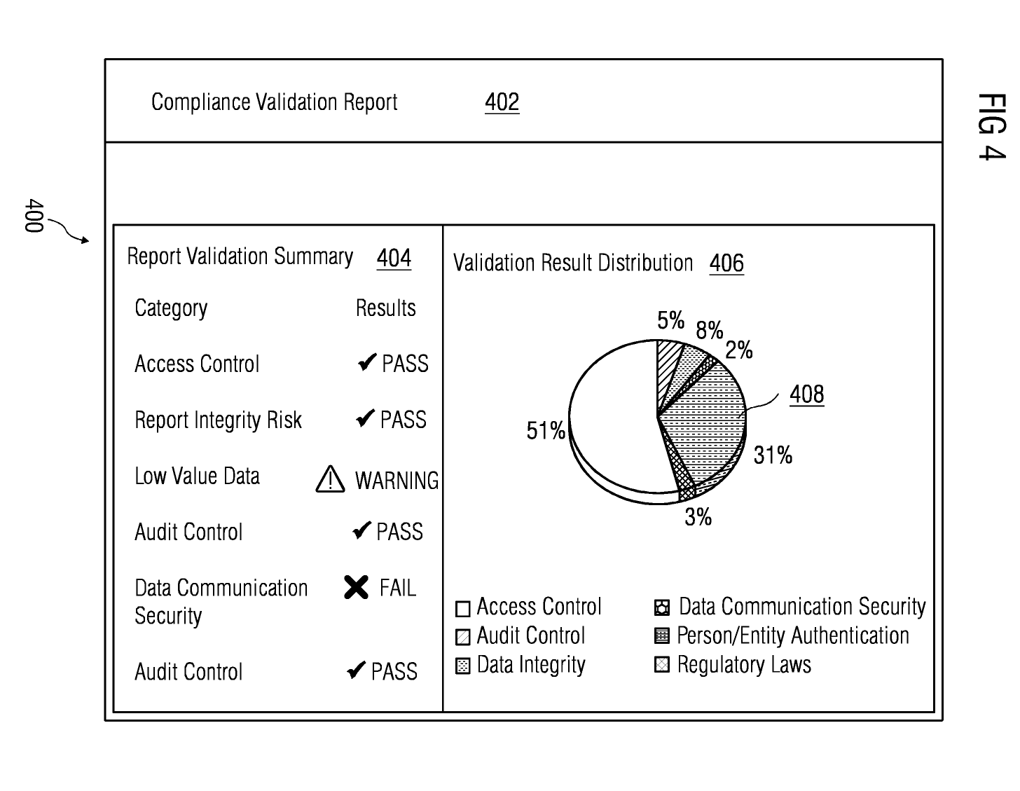

FIG. 3 illustrates an exemplary environment 300 for performing compliance validation of the medical records, according to the present invention. The environment 300 includes a server 302, a network 304, a rules database 308 and one or more client devices 306a-306n. The server 302 comprises a processor, a memory, a network interface, and a storage unit (Not shown in FIG. 3). The processor is configured for processing requests from one or more client devices 306a-n, executing machine-readable instructions stored in the memory, and providing response to the client devices 306a-n. The memory comprises the medical record compliance module, such as medical record compliance module 106, stored in the form of machine-readable instructions and executable by the processor. The server retrieves one or more rules from the rules database 308.

The rules database 308 may include a storage unit which hosts one or more rules. The rules include one or more of, but not limited to, territorial rules and an industry standard rules. The rules in the storage unit may be updated when there are any changes in the rules. In an instance, the rules database may be maintained locally by a healthcare provider. The healthcare provider may manually update the rules database 308 when the rules concerning the healthcare systems or medical records are modified. In another instance, the rules may be maintained in a database server which is located remotely. The rules may be retrieved from the server 302 as and when required.

The client devices 306a-n may include a tablet computer, a desktop, a laptop, a smart phone and the like devices. The client devices 306a-n comprises processors, input/output devices, and communication module respectively. The input/output devices may be keyboard, mouse, display unit, touch screen display interface. The input/output devices enables the users to input commands for interacting with the server 302 or output response received from the server 302. The communication modules enables the respective client devices 306a-n to communicate with the server 302 via the network 304.

When users of the client devices 306a-n wish to valdiate the compliance of one or more medical records, the users of the client devices 306a-n access the medical record compliance module 106 in the server 302 via the network 304. For example, the processors in the client devices 306a-n sends a request to access the medical record compliance module 106 to the server 302 via the network 304 using the respective communication modules. Accordingly, the processor of the server 302 provides access to the the medical record compliance module 106 to each of the client devices 306a-n. Consequently, an GUI editor is displayed on each of the client devices 306a-n. Thus, the users of the client devices 306a-n can select the rules to validate the one or more medical records.

In an exemplary scenario, a hospital staff member runs a compliance validation on a number of medical records. The staff member cannot access of see the contents of the medical records as the medical records are access restricted. The staff member may be able to see an identification number of the medical record. The staff member may select one or more medical records, based on the identification number, which must face the compliance validation. Further, the staff member may select one or more of, but not limited to, a rule template and one or more rules that the medical records must be validated against. Thereafter, the receiving module 202 receives the medical records. The compliance validation module 204 then retrieves the one or more rules selected by the staff member from a database. In an instance, the rule may be stored locally within the computing device 100, in the storage unit 108. After retrieving the rules, the compliance validation module 204 parses the one or more medical records. The content of the medical records are parsed and compared against the rules. In an exemplary scenario, the medical record may be parsed in accordance with the field to be verified by the rule. For example, if the rule states that a date of generation of the medical record is compulsory, then the date field of the medical record is parsed in the medical record. Similarly, the medical records are parsed and compared with the one or more rules to validate the compliance of the medical record. In an example, the rules may be related to access control of the medical report, audit control, data integrity of the medical record and encryption standard of the medical record. During the validation of the medical records, the compliance validation module 204 is isolated and is configured not to display any information associated with the medical record. Any request originating from the staff member to display the information is blocked or diverted. The compliance validation module 204 performs the compliance validation of the selected medical records and provides the results to the report generation module 206.

FIG. 4 illustrates an exemplary compliance report 402 according to the invention. The report generation module 206 analyzes the information provided by the compliance validation module 204. Based on the results, one or more indications of a level of compliance of the medical record are generated. In FIG. 4, the compliance report includes a report validation summary 404. The report validation summary 404 includes information regarding a level of compliance of the medical record. The report validation summary 404 includes a category of rules that are checked for compliance and a result of the compliance check. Any failure in compliance is highlighted. Further, the compliance report 402 includes a visual indication such as, a validation result distribution 406. The validation result distribution 406 is a sector graph which indicates the overall results of the compliance validation of the medical records. The compliance report 402 can include visual indications such as bar graph and line graph indicating the level of compliance of the medical records. The compliance report 402 can include results pertaining to access control rules, audit controls, data integrity, Person Identification and encryption standards. Based on the compliance validation report 402, the staff can take one or more corrective measures to ensure the medical records adhere to the rules.

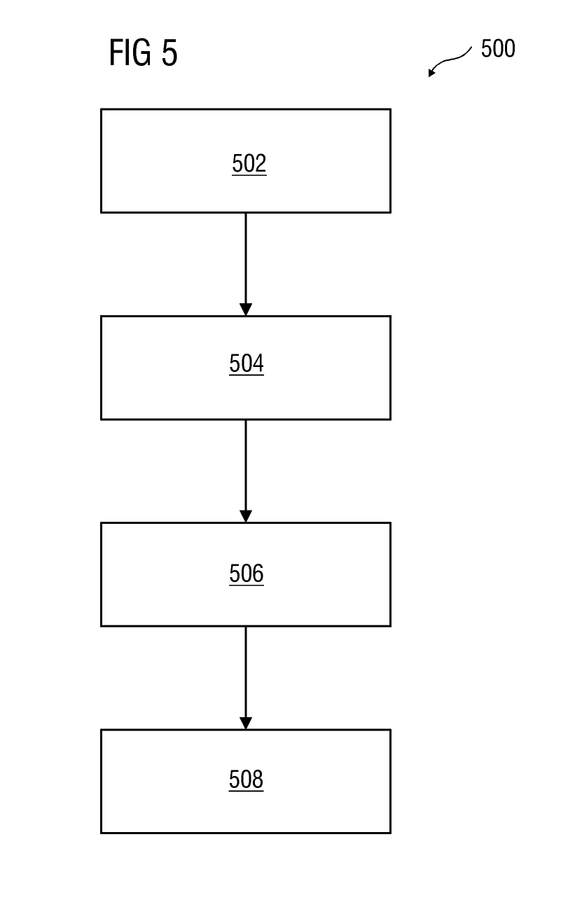

FIG. 5 illustrates an exemplary flow diagram of method steps for validating the compliance of the medical records, according to the present invention. At step 502, one or more medical records are received using a processor. The medical record may be received from at least one of a database, a computing device and an imaging modality. The medical record may include at least one of personal details of a patient, a clinical condition, values and annotations associated with the clinical condition and the like. Further, the medical record includes access restrictions and can be accessed only by authorised personnel such as, a physician and a patient.

At step 504, a content of the medical records are analyzed against one or more rules. For example, the content of the medical records may be parsed and compared with one or more rules. In an instance the rules can be selected by a staff member using input means. In another instance, the rules may include regulations pertaining to privacy, completeness and integrity of medical records specified by a regulatory authority. The rules may be stored in a database which may be located remotely.

At step 506, the conformance of the medical records to the one or more rules is determined. The content of the medical record is compared against the rules to check if the content of the medical record conforms to the rules. For example, a rule may state the medical record must mandatorily include a blood group of the patient. In case any of the medical records do not include the blood group of the patient such information is highlighted in the medical report.

At step 508, a compliance report is generated which includes a level of compliance of the record with at least one rule. For instance, the compliance report includes a level of data integrity, a level of integrity and robustness of the encryption standard used for securing the medical record. Further, the compliance report provides warnings if there are critical information missing, in the medical record, which is required according to the rules.

The present invention can take a form of a computer program product comprising program modules accessible from computer-usable or computer-readable medium storing program code for use by or in connection with one or more computers, processors, or instruction execution system. For the purpose of this description, a computer-usable or computer-readable medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processors and program code for implementing each aspect of the technology can be centralized or distributed (or a combination thereof) as known to those skilled in the art.

While the present invention has been described in detail with reference to certain embodiments, it should be appreciated that the present invention is not limited to those embodiments. In view of the present disclosure, many modifications and variations would be present themselves, to those skilled in the art without departing from the scope of the various embodiments of the present invention, as described herein. The scope of the present invention is, therefore, indicated by the following claims rather than by the foregoing description. All changes, modifications, and variations coming within the meaning and range of equivalency of the claims are to be considered within their scope.

What is claimed is:

1. A method of validating a medical record according to compliance rules governing the content of the medical record, the method comprising:
receiving, by a processor, one or more medical records, wherein the medical records includes access restrictions;
analyzing a content of the medical records against at least one rule;
determining if the one or more medical records conform to the at least one rule;
generating a compliance report, wherein the compliance report includes a level of compliance of the one or more medical records with the at least one rule.

2. The method of claim 1, wherein the access restrictions associated with the medical records restricts the visibility of the medical records to at least one authorized entity.

3. The method according to claim 1, wherein analyzing the medical record includes analyzing the medical record for at least one of, access rights, presence or absence of information, authentication requirements, encryption standards.

4. The method according to claim 1, wherein the at least one rule is based on at least one of an industry standard regulation and a territorial regulation.

5. The method according to claim 1, wherein comparing the content in the medical record involves determining one or more rules that are compared with the content.

6. The method according to claim 1, wherein the rules are converted into an XML schema.

7. The method according to claims 1, wherein the medical record is received from at least one of a database and an imaging modality.12

8. The method according to claim 1, wherein the comparison of the content of the medical record with the rules is performed without displaying the contents of the medical record.

9. The method according to claim 1, wherein the compliance report includes at least one indication from the group of results of integrity tests, value of data, adherence to the rules, presence or absence of critical data.

10. The method according to claim 9, wherein the compliance report includes one or more visual representations illustrating the at least one indication.

11. The method according to claim 1, wherein the medical record includes at least one of an electronic medical record (EMR), an electronic health record (EHR), a medical image and a clinical record.

12. A system for validating a medical record according to compliance rules governing the content of the medical record, the system comprising:
a processor;
a memory coupled to the processor, wherein the memory includes:
a receiving module, configured to receive one or more medical records, wherein the one or more medical records include access restrictions;
an compliance validation module, configured to analyze a content of the medical records against one or more rules and determine if the medical record conforms to the one or more rules;
a record generation module, configured to generate a record, wherein the record includes one or more indications of a level of compliance of the record with at least one rule.

13. The system according to claim 12, wherein the receiving module is configured to receive medical records from at least one of a database and an imaging modality.

14. The system according to claim 12, wherein the compliance validation module is configured to compare the medical records with the rules without displaying the content of the medical record.

15. The system according to claim 12, wherein the compliance validation module is configured to convert the rules into XML (eXtensible Markup Language) format.

16. The system according to claim 12, wherein the compliance validation module determines one or more rules that are compared against the content of the medical record.

17. The system according to claim 12, wherein the one or more rules are selected by an input means.

18. The system according to claim 12, wherein the compliance validation module is configured to analyze the medical record for at least one of, access rights, presence or absence of information, authentication requirements, encryption standards and the like.

19. The system according to claim 12, wherein the compliance validation module is configured to retrieve one or more rules from a rules database.

20. The system according claims 12, wherein the rules database is updated based on the changes to the one or more rules.

21. The system according to claim 12, wherein the report generation module is configured to generate a compliance report indicating at least one of data integrity, completeness, adherence to the rules, presence or absence of critical data, encryption type and the like.

22. The system according to claim 12, wherein the report generation module is configured to generate a compliance report including at least one visual indication illustrating the overall compliance of the medical record.
